(19) United States
(12) Patent Application Publication
(10) Pub. No.: US 2013/0253102 A1
(43) Pub. Date: Sep. 26, 2013

(54) BIODEGRADABLE PLASTIC MATERIAL

(71) Applicant: Sung-Yuan LIU, Taichung City (TW)

(72) Inventor: Sung-Yuan LIU, Taichung City (TW)

(21) Appl. No.: 13/430,202

(22) Filed: Mar. 26, 2012

(51) Int. Cl. C08L 3/00

(52) U.S. Cl. 524/47

(57) ABSTRACT

A novel high-performance biodegradable plastic material based on biodegradable polyester and starch applying LDI(L-Lysine Diisocyanate) as coupling agent.

### BACKGROUND OF THE INVENTION

1. Field of the Invention

The present invention relates carbon reduction eco-friendly materials and more particularly, to a biodegradable plastic material.

2. Description of the Related Art

Many biodegradable plastic materials are commercially available. These biodegradable plastic materials are eco-friendly, however, they still have some drawbacks. For example, some commercial biodegradable plastic materials are not 100-percent biodegradable; some other commercial biodegradable plastic material are highly biodegradable but with a low level of structural strength. These drawbacks limit the applications of the conventional biodegradable plastic materials. Therefore, there is a strong demand for optimal biodegradable plastic materials that eliminate the aforesaid drawbacks.

### SUMMARY OF THE INVENTION

The present invention has been accomplished under the circumstances in view. It is the main object of the present invention to provide a biodegradable plastic material, which is highly degradable and has a high level of structural strength.

To achieve this and other objects of the present invention, a biodegradable plastic material comprises 50 wt %˜70 wt % biodegradable polyester, 25 wt %˜50 wt % starch, and 0.5 wt %˜2 wt % LDI (L-Lysine Diisocyanate).

### DETAILED DESCRIPTION OF THE INVENTION

The advantages and features of the present invention will be fully understood by way of examples in conjunction with the related test results. A biodegradable plastic material in accordance with the present invention comprises 50 wt %˜70 wt % biodegradable polyester selected from the group of PBS (Poly Butylenes Succinate), PCL (Poly Capro Lactone), PLA (Poly Lactic Acid), PBSA (Poly Butylene Succinate-co-Adipate), PBAT (Poly Butylene Adipate-co-Terephthalate), PGA(Poly Glycolic Acid) and PVA (Poly Vinyl Alcohol), 25 wt %˜50 wt % starch selected from the cereal starch group of α starch, corn starch, potato starch, manioc starch, rice starch and wheat starch, and 0.5 wt %˜20 wt % LDI (L-Lysine Diisocyanate).

The biodegradable plastic material can be used as a base material, or mixed with other plastic materials in a proper percentage for making a biodegradable plastic product having excellent structural strength.

The following Table I and Table II are material strength test results from examples of group A prepared according to the present invention, wherein the percentage in Table I is a percentage by weight; the percentage by weight of biodegradable polyester in examples of group A is 60%.

TABLE I

| | A-1 | A-2 | A-3 | A-4 | A-5 |
|---|---|---|---|---|---|
| PBS (Poly Butylene Succinate) | 100% | 60% | 60% | 60% | 60% |
| 60% | | | | | |
| α starch 40% | — | 40% | 39.5% | 39% | 38% |
| LDI (L-Lysine Diisocyanate) | — | — | 0.5% | 1% | 2% |
| 0.5%~2% | | | | | |

TABLE II

| | Test | | | | | | |
|---|---|---|---|---|---|---|---|
| Properties | method | Unit | A-1 | A-2 | A-3 | A-4 | A-5 |
| Elongation | ASTM | % | 600 | 80 | 60 | 50 | 20 |
| at Break | D638 | | | | | | |
| Melt flow | ASTM | g/10 min | 12 | 5.5 | 2.8 | 1.6 | 0.4 |
| index@ | D1238 | | | | | | |
| 2.16 kg/ | | | | | | | |
| 150° C. | | | | | | | |
| Tensile | ASTM | Kgf/cm² | 343 | 127.4 | 294 | 341 | 352.8 |
| Strength | D638 | | | | | | |
| Izod notched | ASTM | Kgf/cm² | 4 | 1.2 | 3.2 | 3.72 | 2.8 |
| impact | D256 | | | | | | |
| strength | | | | | | | |

From the above listed test results, it can be known that the modified material compositions still maintain a high level of material strength.

The following Table III and Table IV are material strength test results from examples of group B prepared according to the present invention, wherein the percentage by weight of biodegradable polyester in examples of group B is 50%.

TABLE III

| | | B-1 | B-2 | B-3 |
|---|---|---|---|---|
| PBS(Poly Butylene Succinate) | 50% | 50% | 50% | 50% |
| α starch | 50% | 49.5% | 49% | 48% |
| LDI (L-Lysine Diisocyanste) | 0.5%~2% | 0.5% | 1% | 2% |

TABLE IV

| Properties | Test method | Unit | B-1 | B-2 | B-3 |
|---|---|---|---|---|---|
| Elongation at Break | ASTM D638 | % | 50 | 42 | 15 |
| Melt flow | ASTM | g/10 min | 1.11 | 0.36 | 0.05 |
| index@2.16 | D1238 | | | | |
| kg/150° C. | | | | | |
| Tensile Strength | ASTM D638 | Kgf/cm² | 343.5 | 362 | 358 |
| Izod notched | ASTM D256 | Kgf/cm² | 2.12 | 3.07 | 1.75 |
| impact strength | | | | | |

The following Table V and Table VI are material strength test results from examples of group C prepared according to the present invention, wherein the percentage by weight of biodegradable polyester in examples of group C is 70%.

TABLE V

| | | C-1 | C-2 | C-3 |
|---|---|---|---|---|
| PBS(Poly Butylene Succinate) | 70% | 70% | 70% | 70% |
| α starch | 30% | 29.5% | 29% | 28% |
| LDI (L-Lysine Diisocyanste) | 0.5%~2% | 0.5% | 1% | 2% |

TABLE VI

| Properties | Test method | Unit | C-1 | C-2 | C-3 |
|---|---|---|---|---|---|
| Elongation at Break | ASTM D638 | % | 95 | 73 | 45 |
| Melt flow | ASTM D1238 | g/10 min | 2.77 | 0.75 | 0.15 |
| index@2.16 kg/150° C. | | | | | |
| Tensile Strength | ASTM D638 | Kgf/cm² | 340 | 356 | 335 |
| Izod notched impact | ASTM D256 | Kgf/cm² | 3.85 | 4.01 | 2.74 |
| strength | | | | | |

From the test results of the above-mentioned various groups of samples prove that the biodegradable plastic material of the present invention provides a high level of structural strength. More particularly, the biodegradable plastic material gives the best tensile strength when containing biodegradable polyester 50 wt %, starch 49 wt % and LDI (L-Lysine Diisocyanate) 1 wt %, or the best impact strength when containing biodegradable polyester 70 wt %, starch 29 wt % and LDI (L-Lysine Diisocyanate) 1 wt %.

The samples received ISO14855-1 biodegradability evaluation test in Plastics Industry Development Center, and the test result is also listed in the attached Annex I. The test result indicates 50% degradability after 59 days, or 99% degradability after 113 days, as shown in Annex I.

From the above-mentioned test results, the biodegradable plastic material of the invention is highly biodegradable compound material that provides a high level of structural strength.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A biodegradable plastic material, comprising:
50 wt %˜70 wt % biodegradable polyester;
25 wt %˜50 wt % starch; and
0.5 wt %˜2 wt % LDI (L-Lysine Diisocyanate).

2. The biodegradable plastic material as claimed in claim 1, wherein said biodegradable polyester is selected from the group of PBS (Poly Butylenes Succinate), PCL (Poly Capro Lactone), PLA (Poly Lactic Acid), PBSA (Poly Butylene Succinate-co-Adipate), PBAT (Poly Butylene Adipate-co-Terephthalate), PGA(Poly Glycolic Acid) and PVA (Poly Vinyl Alcohol).

3. The biodegradable plastic as claimed in claim 1, wherein said starch is selected from the cereal start group of α starch, corn starch, potato starch, manioc starch, rice starch and wheat starch.

4. The biodegradable plastic material as claimed in claim 1, wherein said biodegradable polyester is preferably 60 wt %˜70 wt %; said starch is preferably 29 wt %˜39 wt %; said LDI (L-Lysine Diisocyanate) is preferably 0.5 wt %˜1 wt %.

5. The biodegradable plastic material as claimed in claim 1, which has a tensile strength over 290 kgf/cm² under ASTM D638 plastic tensile strength test method.
